(19) United States
(12) Patent Application Publication
(10) Pub. No.: US 2026/0111826 A1
(43) Pub. Date: Apr. 23, 2026

(54) METHOD OF DISCOVERING PROCESS-BASED DRIVERS FOR CASE-LEVEL OUTCOME EXPLANATION

(71) Applicant: Celonis SE, Munich (DE)

(72) Inventor: Xu CHU, Munich (DE)

(73) Assignee: Celonis SE, Munich (DE)

(21) Appl. No.: 19/363,295

(22) Filed: Oct. 20, 2025

Related U.S. Application Data
(60) Provisional application No. 63/709,717, filed on Oct. 21, 2024.

(51) Int. Cl. G06Q 10/0639; G06F 17/18

(52) U.S. Cl. CPC G06Q 10/06393; G06F 17/18

(57) ABSTRACT

A method of discovering process-based drivers in an event log table includes generating a number of process based features and joining them with the case table on the case ID obtaining a dataset, generating drivers, with each driver constraining another feature and attribute value, associating a driver score to each of the drivers, and retaining a set of drivers with the highest scores. The method then repeated extends each of the drivers of the set by one additional constraint and obtains drivers d′, associating a driver score with each driver d′. If the driver score is larger than the score of the driver prior to the extending step, d*, replacing d* by d′. The method retains the number of drivers d* with the highest scores as an updated set, repeats the step iteratively, and outputs the driver d* with the highest score out of the updated set.

### BACKGROUND

The present invention relates to a method of discovering process-based drivers for case-level outcome explanation. Such a method is applied in process mining.

Process mining is a discipline that aims to discover, monitor, and improve real-world processes. The growing interest in this discipline can be attributed to the increasing availability of recorded process execution data in businesses, as well as the strong desire to improve business outcomes, measured in various Key Performance Indicators (KPIs) [3]. A KPI for process operation is typically measured by taking a historical event log and calculating an aggregation over case-level outcomes. For example, on-time delivery rate as a KPI is calculated as the percentage of cases that have an outcome of being delivered on time; and average throughput time is calculated as the average time it takes to complete the execution of cases. Using process mining to discover process inefficiencies, execution gaps have shown significantly impact in terms of improving business KPIs.

In the experience of delivering process mining solutions to customers for improving their KPIs, there are some important and common questions that are frequently encountered: Why is a certain KPI so low (or high)? What causes certain cases to have a negative outcome, and hence affecting the overall KPIs? To answer these real-world questions, the problem of Driver Discovery is addressed in this invention. Drivers refer to the explanations that are most likely to drive a particular case-level outcome, and hence have a direct impact on KPIs. In particular, we want to make use of the event log and discover process-based drivers that contain information about the events or activities in event log traces. The motivation is that process data which describes the execution trace of a case should reveal the fundamental root cause of case-level outcomes. For example, certain cases experiencing long throughput times can be attributed to the involvement of a particular manual activity in their event log traces.

### OBJECTS OF THE INVENTION

For discovered drivers to be practically useful, they have to be effective, significant, and interpretable. Intuitively, a driver is effective if the probability of observing a certain outcome is highly likely given the driver. A driver should also be significant in that it should cover as many occurrences of a certain outcome as possible. In addition, a driver needs be interpretable so that users can understand the driver, and can then take corresponding actions.

### SUMMARY

These objects are at least partially solved by the methods and systems as defined in the claims.

Provided is a computer-implemented method of discovering process-based drivers, in an event log table L,
the event log L comprising a number of cases, each case comprising a number of traces, each trace comprising a number of unique activities A,
the event log table L being defined as a table comprising a predefined number of columns representative of case ID, activity name and time stamp, {case_id, activity_name, time_stamp}, and
a case table {case_id, X₁, X₂, . . . , Xₘ, Y}, comprising a predefined number of columns, the columns comprising data relating to a case ID, case-level attributes, and outcome of the case, {case_id, X₁, X₂, . . . , Xₘ}, respectively
Xᵢ being a case level attribute,
m being the number of case-level attributes,
Y being a binary output variable representative of an outcome of a case;
the method comprising:
generating, for each case, a number of process based features {Xₘ₊₁, X_{m+2]}, . . . } and joining the process-based features with the case table on the {case_id}, thus obtaining a dataset D,
generating drivers d, each driver d being defined as constraint of another feature Xⱼ and an attribute value vⱼ, (Xⱼ⊙vⱼ), where ⊙ representing a comparison operator ⊙∈{=, ≠, <, >, ≤, ≥},
the feature Xⱼ being one of a group consisting of:
   features X_{A} based on individual activities in a case tᵢ, the features X_{A} being features which appear in all the cases tᵢ of the event log L,
   features X_{D} based on a sequence of activities that directly follow one another in a case, and
   features X_{I} based on a sequence of activities that only indirectly follow one another in a case;
associating a driver score F_{d} to each of the drivers d, the driver score F_{d} being computed according to a predefined criterion,
retaining a number of K of drivers d with the highest driver scores F_{d}, thus obtaining a set B_{cur} of drivers d*, K being a natural number, K>0,
for θ iterations, θ being a natural number >0, repeating the following step:

Extending each of the K drivers d* retained in the preceding step, by one additional constraint (Xⱼ⊙vᵥ), thus obtaining drivers d′←d∧(Xⱼ⊙vⱼ)
associating a driver score F_{d′} to each driver d′, the driver score F_{d′} computed according to the predefined criterion,
if the driver score F_{d′} of the driver is larger than the score of the driver prior to the extending step, d*, replacing d* by d′
retaining the number of K drivers d* with the highest scores F_{d′}, thus obtaining an updated set B_{cur},
repeating the step until the number θ of iterations has been reached, outputting, the driver d′ with the highest score F_{d}. out of the updated set B_{cur}.

In an advantageous embodiment, the predefined criterion is defined as:

$${F}_{{d}^{′}} = {F}_{d} ( D , y ) = 2 {P}_{d} {R}_{d} / ( {P}_{d} + {R}_{d} )$$

$$with$$

$${P}_{d} ( D , y ) = \frac{{\sum }_{{t}_{i} ∈ {D}_{d}} ( {t}_{i} [ Y ] = y )}{\vert {D}_{d} \vert} .$$

where [symbol] is one if tᵢ[Y]=y, and 0 otherwise, and
D_{d}⊆D denotes the subset of cases that fulfill all the attribute constraints specified in driver d, and |D_{d}| is the number of the cases contained in the subset.

According to a further embodiment of the invention, the method further comprises:
Generating the features X_{D} by enumerating all sequences of directly following activities of a case tᵢ,
associating a value of 1 to tᵢ if the sequence appears at least once in the case tᵢ, and of 0 otherwise,
retaining the features X_{D} having a value tᵢ of 1,
computing a precision value P_{X} and a recall value R_{X} for each retained feature X_{D},
removing features X_{D} whose precision and recall values P_{X}, R_{X} arc below predetermined threshold values θₚ, θᵣ.

According to a further embodiment of the invention, the method further comprises:
Generating the features X^{I} by enumerating all sequences of indirectly following activities of a case tᵢ,
associating a value of 1 toₜi if the feature's sequence's activities appear in the right order at least once in the case's trace tᵢ and of 0 otherwise,
computing, for each feature X, predefined precision and recall values P_{X}, R_{X},
removing features X^{I} whose precision and recall values P_{X}, R_{X} arc below predetermined threshold values θₚ, θᵣ.

According to a further embodiment of the invention, the method further comprises:
in a first step, generating a number | [symbol] | candidate features X^{I} of length i=1, | [symbol] | being the number of unique activities A comprised in the log L,
calculating recall value R_{X} of the candidate features X^{I},
retaining only those candidate features X^{I} whose recall value R_{X} is larger than or equal to a predefined recall threshold value θᵣ, thus obtaining a set of frequent candidates,
performing the iteration step:
incrementing the length i by 1,
generating candidate features of length i using the set of frequent candidates resulting from the previously executed step,
calculating the recall value R_{X} of the candidate features X^{I} of length i,
retaining only those candidate features X^{I} whose recall value R_{X} is larger than or equal to the predefined recall threshold value θᵣ, thus obtaining an updated set of frequent candidates,
repeating the iteration step until there are no more frequent candidates,
calculating the precision value P_{X} for all candidates of the set of candidates, keeping those indirect sequence feature X^{I} whose precision values P_{X} are larger than or equal to a predefined threshold value θₚ, the value θₚ being a natural number θₚ>0.

Herein, the precision and recall values P_{X}, R_{X} may be defined as follows:

$${P}_{X} = \frac{{\sum }_{{t}_{i} ∈ D} ( {t}_{i} [ Y ] = y ) \& {t}_{i} [ X ] = 1}{{\sum }_{{t}_{i} ∈ D} {t}_{i} [ X ] = 1} ,$$

$${R}_{X} = \frac{{\sum }_{{t}_{i} ∈ D} ( {t}_{i} [ Y ] = y ) \& {t}_{i} [ X ] = 1}{{\sum }_{{t}_{i} ∈ D} ( {t}_{i} [ Y ] = y )} .$$

Yet further, the invention provides a machine-readable storage medium comprising instructions which when loaded into a computer system controls the computer system to perform the inventive method as described above.

Still further, the invention provides a computer program comprising instructions which, when the program is executed by a computer, cause the computer to perform the inventive method as described above.

Thus, the present invention provides novel methods and systems to discover drivers on process data that meet those requirements.

The invention makes, among others, the following contributions:
The problem of process-based driver discovery is defined as a constrained optimization problem. A discovery workflow is provided.
Three categories of process-based features are provided, as well as efficient methods to enumerate and prune such features.
Given that the driver discovery problem is NP-hard, an efficient algorithm is developed based on beam search to solve the prob-1 cm.
The method according to the invention is evaluated on real-world datasets. The experiment results show the effectiveness and efficiency of the new method.

### BRIEF DESCRIPTION OF THE DRAWINGS

FIG. 1 illustrates the overall workflow;

FIG. 2 illustrates a pseudocode representation of the algorithm;

FIGS. 3, 4, 5 illustrate the flow diagram of the algorithm;

FIG. 6 illustrates a knob analysis; and

FIG. 7 illustrates a running time comparison.

### DETAILED DESCRIPTION

### Input Data and Discovery Workflow

Data Model. We assume a standard case-centric event log data model. In particular, we assume as input a case table and an event log table. The case table has columns {case_id, X₁, X₁, X₂, . . . . Xₘ, Y}. {X₁, X₂, . . . . Xₘ} are case-level attributes, Y is the case-level outcome. We assume in this paper that the target variable Y is a binary outcome variable, while the attributes Xᵢ can be cither numerical or categorical. The event log table has the three columns {case_id, activity_name, time_stamp}.

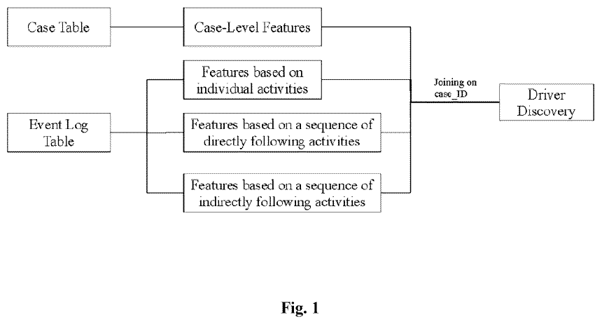

Discovery Workflow. In process mining, the event log records the execution traces of individual cases. The execution trace of a case contains valuable source information and signals that might explain the outcome of a case. How do we leverage the execution traces of cases, together with case-level attributes? FIG. 1 shows the overall workflow: First, the event log table is flattened by generating multiple process-based features {Xₘ₊₁, Xₘ₊₂, . . . } for each case, which are then joined with the case table on the {case_id} column. For example, for every unique activity A in the event log, we will create a process-based feature X_{A} to indicate the number of times the activity A appears in each case.

KPI Driver Formal Definition and Goodness. Given a binary outcome Y=y∈{0, 1} to explain, we formally define a driver d as a conjunction of constraints on a subset of attribute values:

$$d := ( {X}_{1} ⊙ {v}_{1} ) ∧ ( {X}_{2} ⊙ {v}_{2} ) … ∧ ( {X}_{k} ⊙ {v}_{k} ) \qquad ( 1 )$$

where Xⱼ∈X is a feature that could be a case-level feature or a flattened process-based feature, vⱼ is a feature value and ⊙∈{=, ≠, <, >, ≤, ≥} is a comparison operator.

Given that there are exponential number of drivers with respect to the number of features considered, we define the following goodness metrics for drivers based on various conversations with customers. Let D={tᵢ|i∈[n]} denote the joined dataset (c.f. FIG. 1) with n cases, where tᵢ is the i^{th} case. Let D_{d}⊆D denote the subset of cases that fulfill the attribute constraints specified in the driver d:
Effectiveness (high precision). Given a particular outcome Y=y, good drivers should effectively drive that outcome rather than preventing the occurrence of that outcome. Therefore, a good driver d should be effective, or has high precision, if for cases that satisfy the driver conditions, the probability of the occurrence of the given outcome is high. Formally, this is written as

$${P}_{d} ( D , y ) = \frac{{\sum }_{{t}_{i} ∈ {D}_{d}} ( {t}_{i} [ Y ] = y )}{\vert {D}_{d} \vert} .$$

Significance (high recall). Good drivers are supposed to cover as many cases with the interested outcome as possible. This is especially important if the driver is used to find the underlying reasons for some issues, such as identifying the reasons for low KPI. If the driver only covers a small number (e.g., 1%) of low-KPI cases, it cannot be used to significantly improve the KPI even if the driver is effective. Hence, a good driver should be significant, or has high recall, if it covers as many occurrences of a given outcome as possible. This property can be formally written as

$${R}_{d} = \frac{{\sum }_{{t}_{i} ∈ {D}_{d}} ( {t}_{i} [ Y ] = y )}{{\sum }_{{t}_{i} ∈ D} ( {t}_{i} [ Y ] = y )} .$$

Interpretability. Good drivers should be easily interpretable, and hence users can take actions to fix the problem. Intuitively, the simpler the driver is, the easier it can be understood.
Let |d| denote the number of attributes in the driver. Then, we use |d| as the proxy metric for interpretability.

The goal is to find a good driver that is effective, significant and easily interpretable. However, it may not be possible to optimize all three properties simultaneously.

To balance the trade-off between effectiveness and significance, inspired by using F-score [11] to balance precision-recall trade-off, we combine the effectiveness and significance into one metric denoted by

$${F}_{d} : {F}_{d} ( D , y ) = \frac{2 {P}_{d} {R}_{d}}{{P}_{d} + {R}_{d}} .$$

This metric will be high as both effectiveness and significance are high. Either a low effectiveness or low significance will result in a low score. Therefore, optimizing F_{d} will yield a driver with a good balance on effectiveness and significance. For interpretability, in practice, if the number of attributes involved in the driver is not too large (e.g., [d]≤3), its interpretability is generally acceptable. Therefore, we only need to ensure |d| under a threshold θ (e.g., θ=3) to make it easily interpretable rather than optimize it.

Driver Discovery Problem. Given a dataset D and an outcome y, we would like to select a driver d that maximizes the metric F_{d}, while keeping the number of constraints (denoted by |d|) smaller than θ. This can be written as a constrained optimization problem as follows.

$$arg {max}_{d} {F}_{d} ( D , y ) s . t . \vert d \vert \leq θ$$

Problem Complexity. A naive way to solve this constrained optimization problem is to enumerate all drivers with |d|≤θ and return the one with the highest score. For datasets with categorical attributes only, the number of possible drivers with at most θ constraints is O((mc)^{θ}), where m is the number of attributes, c is the number of possible attribute values. Consider m=100 and c=10. Even for θ=3, there would be 1 billion possible drivers, let alone that there are infinite drivers for datasets with numerical attributes. Therefore, this naive approach is not feasible in practice. In fact, it can be proven that the problem is NP-hard (formal proof omitted due to space).

### Process-Based Feature Engineering

Three categories of process-based features are included: (1) features based on individual activities; (2) features based on a sequence of activities that directly follow one another; and (3) features based on a sequence of activities that indirectly follows one another.

Feature Selection. Given the exponential number of sequence-based features, we perform feature selection based on their effectiveness (precision) and significance (recall). As we will see, our sequence-based (directly follow and indirectly follow) features are binary features. We define the precision P_{X} and recall R_{X} of a binary feature X with respect to a target outcome y as follows:

$${P}_{X} = \frac{{\sum }_{{t}_{i} ∈ D} ( {t}_{i} [ Y ] = y ) \& {t}_{i} [ X ] = 1}{{\sum }_{{t}_{i} ∈ D} {t}_{i} [ X ] = 1} ,$$

$${R}_{X} = \frac{{\sum }_{{t}_{i} ∈ D} ( {t}_{i} [ Y ] = y ) \& {t}_{i} [ X ] = 1}{{\sum }_{{t}_{i} ∈ D} ( {t}_{i} [ Y ] = y )} .$$

We keep a process-based sequence feature X if its precision and recall are greater than some thresholds P_{X}≥θ₀ and R_{X}≥θᵣ. Note that we set θₚ and θᵣ to low numbers (θₚ=0.5 and θᵣ=0.2 in our experiments) so as not to lose any features which might contribute to useful drivers when combined with other features.
(1) Features based on individual activities. Let [symbol] denote all unique activities. We will create a feature X_{A} for each unique activity A∈ [symbol] that appears in the event log of all cases. For each case tᵢ, the feature value tᵢ[A] is the number of times the activity A appears in the trace of the case tᵢ. The complexity for generating these features is O(| [symbol] |).
(2) Features based on a sequence of directly following activities. A feature in this category consists of a sequence of directly following activities, such as

$${X}_{\{ {A}_{1} , {A}_{2} \}}^{D} or {X}_{\{ {A}_{2} , {A}_{4} , {A}_{5} , {A}_{1} \}}^{D} ,$$

where the superscript D means directly following and the subscript is the activity sequence of the feature. For each case tᵢ, a directly following sequence-based feature value is 1 if the feature's sequence appears at least once as a sub-sequence in the case's event log, and 0 otherwise.

We have two potential ways to generate features in this category. First, we could enumerate all possible sequences using [symbol] , which is exponential O( [symbol] ). However, a feature is only useful if at least one case's feature value is 1. Therefore, we can alternatively generate candidate features by enumerating all cases. For each case tᵢ, we enumerate the start index s and the end index e of the case's trace, and the sub-sequence between s and e would be a candidate feature. The number of features generated this way is O(L²*n), where n is the number of cases and L is the maximum trace length of any case. We first compare the two numbers [symbol] and L²*n, and pick the enumeration method with the lower complexity. In practice, we took the second enumeration option for all datasets we experimented with. We then prune features that do not meet the minimum precision and recall thresholds.
(3) Features based on a sequence of indirectly following activities. A feature here consists of a sequence of indirectly following activities, such as

$${X}_{\{ {A}_{1} , {A}_{2} \}}^{I} or {X}_{\{ {A}_{2} , {A}_{4} , {A}_{5} , {A}_{1} \}}^{I} ,$$

where we superscript I means indirectly following and the subscript is the activity sequence of the feature. For each case tᵢ, in indirectly following sequence-based feature value is 1 if the feature's sequence's activities appear in the right order at least once in the case's trace, and 0 otherwise.

Example 1. Let us consider two features

$${X}_{\{ {A}_{1} , {A}_{2} \}}^{D} and {X}_{\{ {A}_{1} , {A}_{2} \}}^{I} .$$

For a case tᵢ with trace {A1, A4, A2, A5},

$${t}_{i} [ {X}_{\{ {A}_{1} , {A}_{2} \}}^{D} \} = 0 and {t}_{i} [ {X}_{\{ {A}_{1} , {A}_{2} \}}^{I} ] = 1.$$

For this category of features, one will have to enumerate all possible sequences using [symbol] , which is exponential O [symbol] . This is because, the enumeration method starting from cases would have a similar, and sometimes even higher given big n, exponential complexity of O(n×2^{|L|}).

The well-known Apriori algorithm [1] is followed for enumerating and pruning features in this category using a lattice data structure. For the i^{th} level of the lattice, we generate and prune all candidate sequences of length i. The candidates in level i are generated using frequent candidates in the previous level i−1. Specifically, a candidate of length i can only be frequent if all of its sub-sequences of length i−1 are frequent. For example, the indirectly following sequence A₁, A₂, A₃ can only be frequent if A₁, A₂, A₁, A₃, and A₂, A₃ are frequent. Given that one only wants to retain candidate features that are above a certain recall threshold θᵣ, the minimum support, i.e., number of cases where the feature is 1, for a candidate to be frequent is | [symbol] (tᵢ[Y]=y)|×θᵣ. Concretely, the indirectly following sequence features are generated in the following steps:
1. Generate | [symbol] | length 1 candidate using [symbol] . Calculate the support for them and retain only those with support bigger than or equal to | [symbol] (tᵢ[Y]=y)|×θᵣ.
2. Generate length i candidate using the frequent length i−1 candidates. Note that a length i candidate is generated only if all its sub-sequences of length i−1 are frequent.
3. Calculate the support for length i candidates, and retain only the frequent ones. Iterate step (2) and step (3) until we have no more frequent candidates.
4. Calculate the precision of all frequent candidates from all levels and retain those meeting the precision threshold op.

### Driver Discovery Algorithm

Given the hardness of the problem, this section introduces a new greedy algorithm to solve the aforementioned problem. Specifically, an efficient greedy searching algorithm based on beam search is presented.

A straightforward greedy algorithm starts from a driver with no constraint and iteratively adds one constraint with the highest benefit into the driver until the number of constraints in the driver exceeds the given limit. The benefit of a constraint can be computed as the F_{d} score after adding the constraint into the current driver. Note that it is possible that the F_{d} score decreases with any additional constraint. Therefore, we keep track of the driver with the highest F_{d} score during exploration and return it as the final result.

However, this greedy algorithm has a drawback: adding one optimal constraint at each step may not lead to the global optimal driver. For example, assume the global optimal driver is X₁=a∧X₂=b. However, for drivers with one constraint, the optimal driver is X₃=c. Then the greedy algorithm will select X₃=c at the first step and it is no longer possible to reach global optimal driver by adding more constraints.

To increase the probability of finding the best driver, a beam search [12] is used, which is a heuristic search algorithm. Instead of only keeping and developing one best driver at each step, the top K (e.g, K=10) drivers with the highest F_{d} scores in a “beam” are kept. At each step, each driver in the beam is extended with one additional constraint, and the top K resulting drivers are kept for the next step. It will still be kept track of the best driver that has been seen during beam search, and return it as the final result. The term “beam search” refers to the way the algorithm explores the search space by considering a limited number of candidates at each step, forming a “beam” of possible solutions.

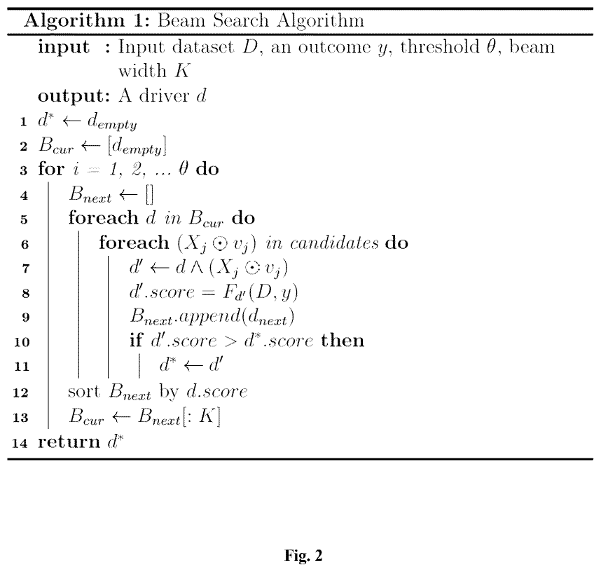

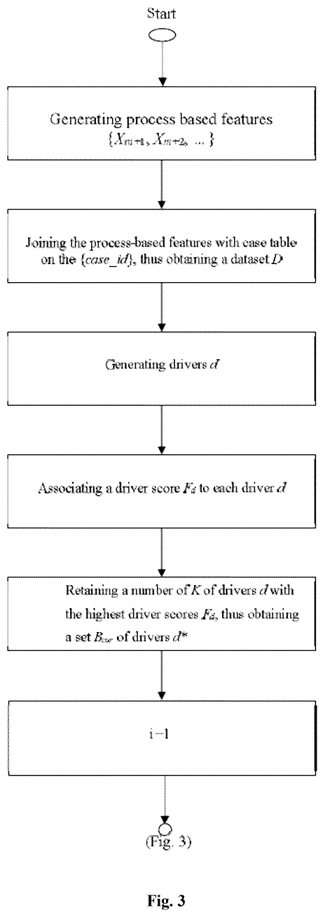

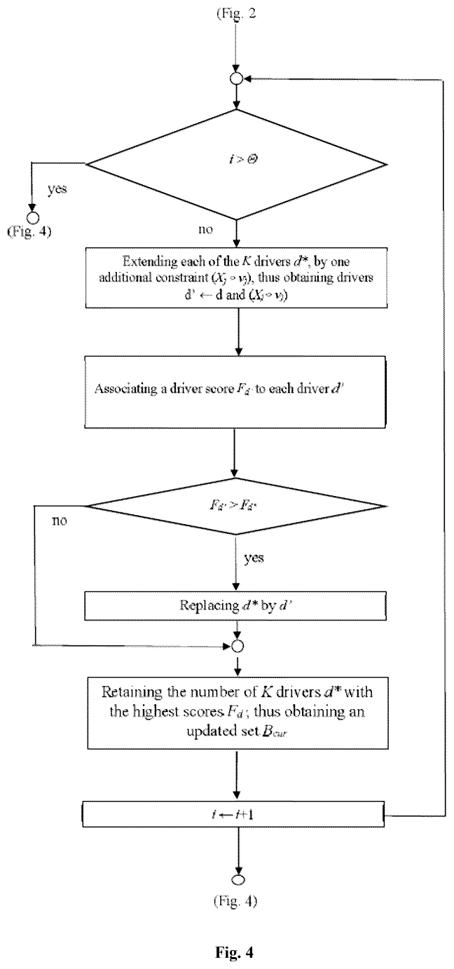

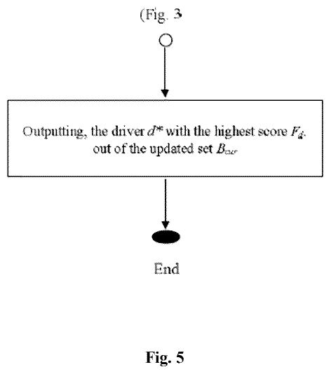

Algorithm. The pseudocode of the beam search algorithm is shown in FIG. 2. Also refer to FIGS. 3, 4, and 5 which show a flow diagram of the beam search algorithm. It is started from an empty driver (Line 1-2). At each iteration, each driver in the beam is extended by one additional constraint (Line 4-7). The candidate set of constraints can be generated by enumerating all possible combination of attributes, operators, and attributes values. For numerical attributes, c splitting points can be chosen (e.g., 10-percentile, 20-percentile, etc) and for each splitting point v, two candidate constraints can be chosen as X≤v and X>v. The F_{d} score of each driver (Line 8) is computed, and the top K drivers with the highest score are kept for the next step (Line 12-13). This process will be repeated for θ iterations such that the number of constraints in the driver will not be greater than θ (Line 3). It is kept track of the best driver d* that has seen (Line 10-11), and it is return at the end

### (Line 14).

Complexity. Consider a dataset with n examples and m features, and each attribute can take c values (assuming numerical attributes are split into c intervals). The number of candidate constraint will be O(mc). Let K be the beam size. For each iteration, the F_{d} score is computed O(Kmc) times, which takes O(nmc) time. Therefore, the total time complexity for the algorithm is O(Knmcθ).

### Related Experiment

The effectiveness and efficiency of both the process-based feature engineering and the beam search algorithm for driver discovery arc evaluated in a experimental setup.

Datasets. Three popular datasets from BPI Challenge are used, which are widely used in the literature, and a synthetic dataset to test the scalability of the driver discovery algorithm. The stats of the datasets are listed in Table 1. BPIC 2017 [7] contains 31,509 loan application cases of a Dutch financial institute; BPIC 2018 [9] contains 43,809 applications for EU direct payments for German farmers from the European Agricultural Guarantee Fund; and BPIC 2019 [8] contains 251,734 purchase orders for a dutch company. For all three real datasets, our target is a binary outcome that indicates whether each case is taking long to finish or not. For a given dataset, a case considered to have long throughput time if it takes longer than 75 percentile throughput time of all cases.

TABLE 1
Dataset Statistics (AAPC: average activities per case; DF: directly
follows features; IDF: indirectly follows features)

| | | #Case | | | | |
|---|---|---|---|---|---|---|
| Dataset | #Cases | Features | #Activities | AAPC | DF | IDF |
| BPIC 2017 | 31,509 | 4 | 26 | 38.2 | 7 | 20 |
| BPIC 2018 | 43,809 | 61 | 41 | 57.4 | 111 | 404 |
| BPIC 2019 | 251,734 | 16 | 42 | 6.3 | 112 | 258 |
| Synthetic | 1,000,000 | 100 | N/A | N/A | N/A | N/A |

Methods Compared. The following driver discovery methods are compared. It is to be noted that all methods use the same feature set generated as described above under “Process-Based Feature Engineering”. Below, the effectiveness of process-based feature engineering will be evaluated, and driver discovery algorithms will be compared.
Beam Search (Bcam): This is the proposed new algorithm as outlined above. By default the maximum number of constraints in a driver θ is set to be 3, and the beam search width K is set to be 8.
Decision Tree (DT): To find the drivers, the decision tree algorithm is run. The decision tree is trained to classify the KPI. Then we down the tree from root to leaf, each path would be a driver and all the points in the leaf would be the cases that satisfies the given driver.
Exhaustive Search (ES): This approach enumerates all possible drivers and find the best one with the highest score.

Evaluation Metrics. F1 score is used to measure the quality of the drivers, as defined in Section. Running time is used to evaluate algorithm efficiency.

### Evaluating Process-Based Feature Engineering

The effectiveness of the process-based feature engineering described above is evaluated. The number of each type of features is shown in Table 1. Specifically, the following feature set is compared in a cumulative manner:
Feature Set A: case-level features only
Feature Set B: features based on activity counts and features in A
Feature Set C: directly following activities and all features in B
Feature Set D: indirectly following activities and all features in C

Qualitative Assessment. The Top-1 driver discovered by each feature set is shown in Table 2. For example, for the BPIC 2017 dataset, an

TABLE 2
Top 1 driver with different set of features on three datasets.

| Features | Top 1 Driver |
|---|---|
| BPIC 2017 A | “Application Type==New credit” & “Requested Amount > 0” |
| BPIC 2017 B | “Count of A_Cancelled > 0” & “Count of A_Submitted > 0” & |
| | “Count of W_Call after offers > 4” |
| BPIC 2017 C | “A_Cancelled directly followed by O_Cancelled” & |
| | “A_Concept directly followed by W_Complete application” & |
| | “Count of W_Call after offers > 4” |
| BPIC 2017 D | “A_Submitted indirectly followed by A_Cancelled” & |
| | “A_Cancelled directly followed by O_Cancelled” & |
| | “Count of W_Call after offers > 4” |
| BPIC 2018 A | “Year==2015” & “number parcels > 3” & “amount applied0 > 1135.24” |
| BPIC 2018 B | “Count of initialize > 4” & “Count of begin preparations <= 0” & |
| | “Count of save > 0” |
| BPIC 2018 C | “Count of initialize > 4” & “amount applied0 > 4025.81” & |
| | “finish payment directly followed by save” |
| BPIC 2018 D | “finish payment indirectly followed by save” & “case year != 2017” |
| BPIC 2019 A | “Item Category != Consignment” & “Item Type != Third-party” |
| BPIC 2019 B | “Count of Record Invoice Receipt > 0” & “Item Type != Third-party” |
| BPIC 2019 C | “Clear Invoice directly followed by Record Invoice Receipt” & |
| | “Item Type != Third-party” & “Count of Record Invoice Receipt>=2” |
| BPIC 2019 D | “Change Quantity indirectly followed by Record Goods Receipt” & |
| | “Item Type != Third-party” & “Count of Record Invoice Receipt>=2” |

important driver is “Count of W_Call after offers >4”, the repetition is likely to be the cause of long throughput time, and is highlighted by the driver discovery algorithm. The directly following feature “A_Cancelled directly followed by O_Cancelled” and the indirectly following feature “A_Submitted indirectly followed by A_Cancelled” show that cancelled cases takes longer than normal cases, which is counter-intuitive.

After looking at the data more deeply, it was noticed that this is caused by automatic cancellation, which takes 30 days and causes long throughput time. For BPIC 2018 dataset, we find that the indirectly following feature “finish payment indirectly followed by save” has a high relevance with long throughput time Overall, the feature generation algorithm presented here can generate features related to

TABLE 3
F1 Score of the driver with feature set.

| Dataset and Feature Set | Top 1 | Top 5 | Top 10 |
|---|---|---|---|
| BPIC 2017 A | 0.429 | 0.429 | 0.428 |
| BPIC 2017 B | 0.650 | 0.648 | 0.643 |
| BPIC 2017 C | 0.653 | 0.652 | 0.649 |
| BPIC 2017 D | 0.655 | 0.653 | 0.650 |
| BPIC 2018 A | 0.647 | 0.646 | 0.646 |
| BPIC 2018 B | 0.714 | 0.713 | 0.708 |
| BPIC 2018 C | 0.718 | 0.716 | 0.710 |
| BPIC 2018 D | 0.906 | 0.905 | 0.903 |
| BPIC 2019 A | 0.506 | 0.506 | 0.505 |
| BPIC 2019 B | 0.522 | 0.521 | 0.521 |
| BPIC 2019 C | 0.532 | 0.530 | 0.523 |
| BPIC 2019 D | 0.535 | 0.532 | 0.527 |

TABLE 4
F1 Score of the Top 1 driver with driver discovery algorithm,
NA means that the algorithm cannot finish in 1 day.

| Dataset | Beam | DT | ES |
|---|---|---|---|
| BPIC 2017 D | 0.655 | 0.608 | 0.664 |
| BPIC 2018 D | 0.906 | 0.904 | NA |
| BPIC 2019 D | 0.535 | 0.493 | NA |

the process and provide insightful patterns that are worth looking into more carefully.

Quantitative Assessment. Table 3 shows the F1 score of top drivers found by our algorithm. Here top 5 is the average F1 score of top 5 drivers and Top 10 is the average F1 score of the top 10 drivers. It can be observed that adding the count features can already increase the F1 score significantly compared with only using case-level features, because it is focused on long throughput time as the target and usually long throughput time is closely related to rework, which is captured by the count features. After adding the directly following and indirectly following features, the F1 score also increases, indicating that new features are used in the top drivers, revealing more causes that are related to the processes. Especially, one sees that after adding the indirectly following features, the F1 score of the top-1 driver for the BPIC 2018 dataset (BPIC 2018 D) becomes 0.906, which shows that the driver has very high relevance with the long throughput time.

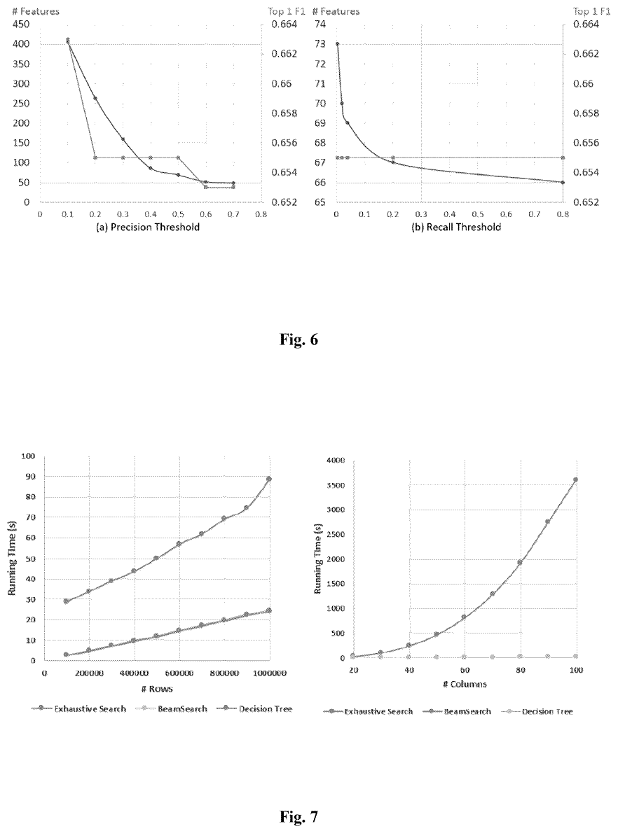

Feature Selection Knob Analysis. It is evaluated how tuning the precision and recall threshold would have an impact on the number of features generated, and the F1 score of the drivers found using the BPIC 2017 dataset. In FIG. 6(a), the recall threshold is fixed to θᵣ=0.2, and the precision threshold θₚ is tuned, it caaaaan be seen that as θₚ becomes higher, there are less features, but the impact on the top 1 F1 is pretty insignificant. Similarly, In FIG. 6(b), the precision threshold is fixed to θₚ=0.5, and the recall threshold θᵣ is tuned, it can be seen that the top 1 F1 does not change at all. The reason is that after the features are generated, the driver discovery algorithm needs still to be run, which would select the high quality features. The selected features in the top drivers usually have high precision and recall, which means that the result is not sensitive on the knob for feature selection.

### Evaluating the Driver Discovery Algorithm

Quality of the driver Evaluated is the F1 score of the found driver using the three algorithms: beam search, decision tree (DT) and exhaustive search (ES), and the result is shown in Table 4. For exhaustive search, it takes a long time to run and cannot finish in 1 day for the BPIC 2018 and BPIC 2019 dataset. For BPIC 2017, exhaustive search achieved the highest F1 score at 0.664, which is understandable because it searches the entire search space. However, the beam search achieved a F1 score of 0.655, and the difference is less than one percentage point. Compared to the decision tree algorithms, the beam search can consistently outperform the decision tree algorithm significantly, by up to 4.7 percentage points.

Running Time Comparison. The synthetic dataset is used to verify the scalability of driver discovery algorithm. FIG. 7 shows the running time comparison of different methods with varying size of datasets. The left graph illustrates the running time over the number of rows, while the right graph illustrates the running time over the number of columns. As can be seen, in FIG. 7 (left), as the number of rows increases, all three grows linearly, and decision tree and beam search have similar running time, and they are 4× faster than exhaustive search. In FIG. 7 (right), as the number of columns grows, the running of the exhaustive search method grows polynomial and takes over 1 hour to finish when the number of columns is greater than 100. However, both decision tree and beam search algorithm grow almost linearly and thus have a better scalability, and decision tree and beam search have similar running times.

### Related Work

Feature Importance. Our work is related to estimating feature importance in ML, which estimates the impact of each feature on model predictions [10]. Some interpretable ML models provides feature importance by themselves. For example, in logistic regression [6], the weight of a feature indicates its importance. In tree-based methods, such as decision tree [15] and random forest [4], the feature importance is computed as the reduction of the prediction error brought by that feature. Permutation importance [2] defines the importance of feature by the decrease of the model performance when that feature value is randomly shuffled. Chung et al. [5] propose an automated data slicing method to validate ML models to find potential performance issues. Also, SHAP values [17] are used to determine the importance of a feature in ML models to explain KPI changes.

Drivers discovered by our method also refer the most important features in a dataset, but different from feature importance in MI, based on model predictions, our method does not tie to a specific ML model and focuses on the impact of features on outcomes.

Decision Mining in Process Mining. In process mining, decision mining is first introduced in [18] to identify the set of features as rules that define the choices made in a process. An extension to support conditions with disjunctions and inequalities is introduced by de Leoni et al. [14]. A typical limitation of decision tree learning is the assumption of full deterministic process executions and, therefore, non-overlapping rules. Mannhardt et al. introduce an additional step to learn new decision trees for each leaf node in the first iteration for wrongly classified instances. An alignment based approach was introduced in which additionally allows to discover rules associated with XOR-splits/joins and certain types of loops. Our work focuses on the factors that influenced the outcome and not only a particular choice. Consequently, our approach aims to find factors on a case-level end to end instead of a local decision point.

### REFERENCES

1. Agrawal, R., Srikant, R., et al.: Fast algorithms for mining association rules. In: Proc. 20th int. conf. very large data bases, VLDB. vol. 1215, pp. 187-499. Santiago, Chile (1994)
2. Altmann, A., Toloşi, L., Sander, O., Lengauer, T.: Permutation importance: a corrected feature importance measure. Bioinformatics 26(10), 1340-1347 (2010)
3. Badakhshan, P., Wurm, B., Grisold, T., Geyer-Klingeberg, J., Mendling, J., vom Brocke, J.: Creating business value with process mining. The Journal of Strategic Information Systems 31(4) (2022)
4. Breiman, L.: Random forests. Machine learning 45, 5-32 (2001)
5. Chung, Y., Kraska, T., Polyzotis, N., Tae, K. H., Whang, S. E.: Slice finder: Automated data slicing for model validation. In: IEEE 35th International Conference on Data Engineering (ICDE). pp. 1550-1553. IEEE (2019)
6. Cox, D. R.: The regression analysis of binary sequences. Journal of the Royal Statistical Society: Series B (Methodological) 20(2), 215-232 (1958)
7. van Dongen, B.: Bpi challenge 2017 (2017). https://doi.org/10.4121/uuid: 5f3067dff10b-45da-b98b-86ae4c7a310b
8. van Dongen, B.: Bpi challenge 2019 (2019). https://doi.org/10.4121/uuid: d06aff4b79f0-45e6-8ec8-e19730c248f1
9. van Dongen, B., Borchert, F. F.: Bpi challenge 2018 (2018). https://doi.org/10.4121/uuid: 33014451-95e8-4110-98a4-901111204972
10. Hooker, S., Erhan, D., Kindermans, P. j., Kim, B.: Evaluating Feature Importance Estimates. arXiv (2018), https://arxiv.org/pdf/1806.10758.pdf
11. Hossin, M., Sulaiman, M. N.: A review on evaluation metrics for data classification evaluations. International journal of data mining & knowledge management process 5(2), 1 (2015)
12. Kumar, A., Vembu, S., Menon, A. K., Elkan, C.: Beam search algorithms for multilabel learning. Machine learning 92, 65-89 (2013)
13. de Leoni, M., van der Aalst, W. M. P.: Data-Aware Process Mining: Discovering Decisions in Processes Using Alignments. In: Proceedings of the 28th Annual ACM Symposium on Applied Computing. p. 1454-1461. SAC '13, Association for Computing Machinery, New York, NY, USA (2013)
14. de Leoni, M., Dumas, M., García-Bañuelos, L.: Discovering Branching Conditions from Business Process Execution Logs. In: Fundamental Approaches to Software Engineering, pp. 114-129. Springer Berlin Heidelberg (2013)
15. Lewis, R. J.: An introduction to classification and regression tree (CART) analysis. In: Annual meeting of the society for academic emergency medicine in San Francisco, California. vol. 14. Citeseer (2000)
16. Mannhardt, F., de Leoni, M., Reijers, H. A., van der Aalst, W. M. P.: Decision Mining Revisited-Discovering Overlapping Rules. In: Advanced Information Systems Engineering, pp. 377-392. Springer International Publishing (2016)
17. Padella, A., de Leoni, M., Dogan, O., Galanti, R.: Explainable process prescriptive analytics. In: 2022 4th International Conference on Process Mining (ICPM). IEEE (October 2022)
18. Rozinat, A., van der Aalst, W. M. P.: Decision Mining in ProM. In: Lecture Notes in Computer Science, pp. 420-425. Springer Berlin Heidelberg (2006)

1. A computer-implemented method of discovering process-based drivers, in an event log table L,
the event log Z comprising a number of cases, each case comprising a number of traces, each trace comprising a number of unique activities A, the event log table L being defined as a table comprising a predefined number of columns representative of case ID, activity name and time stamp, {case_id, activity_name, time_stamp}, and
a case table {case_id, X₁, X₂, . . . . Xₘ, Y}, comprising a predefined number of columns, the columns comprising data relating to a case ID, case-level attributes, and outcome of the case, {case_id, X₁, X₂, . . . . Xₘ}, respectively,
Xᵢ being a case level attribute,
m being the number of case-level attributes,
Y being a binary output variable representative of an outcome of a case;
the method comprising:
generating, for each case, a number of process based features {Xₘ₊₁, Xₘ₊₂, . . . } and joining the process-based features with the case table on the {case_id}, thus obtaining a dataset D,
generating drivers d, each driver d being defined as constraint of another feature Xⱼ and an attribute value vⱼ, (Xⱼºvⱼ), where “º” representing a comparison operator∈{=, >, <, . . . },
the feature Xⱼ being one of a group consisting of
features X_{A} based on individual activities in a case tᵢ, the features X_{A} being features which appear in all the cases tᵢ of the event log L, features X^{D} based on a sequence of activities that directly follow one another in a case, and
features X^{I} based on a sequence of activities that only indirectly follow one another in a case;
associating a driver score F_{d} to each of the drivers d, the driver score F_{d} being computed according to a predefined criterion,
retaining a number of K of drivers d with the highest driver scores F_{d}, thus obtaining a set B_{cur} of drivers d*,
K being a natural number, K>0
for Θ iterations, Θ being a natural number >0, repeating the following step:
Extending each of the K drivers d* retained in the preceding step, by one additional constraint (Xⱼ ºvⱼ), thus obtaining drivers d′←d and (Xⱼºvⱼ)
associating a driver score F_{d′} to each driver d′, the driver score F_{d′} computed according to the predefined criterion,
if the driver score F_{d′} of the driver is larger than the score of the driver prior to the extending step, d*, replacing d* by d′,
retaining the number of K drivers d* with the highest scores F_{d′}, thus obtaining an updated set B_{cur},
repeating the step until the number (of iterations has been reached,
outputting, the driver d* with the highest score F_{d} out of the updated set B_{cur}.

2. The method of claim 1, wherein:
the predefined criterion is defined as:
$${F}_{d} = {F}_{d} ( D , y ) = 2 {P}_{d} {R}_{d} / ( {P}_{d} + {R}_{d} )$$
$$with$$
$${P}_{d} ( D , y ) = \frac{{\sum }_{{t}_{i} ∈ {D}_{d}} ( {t}_{i} [ Y ] = y )}{\vert {D}_{d} \vert}$$
$${R}_{d} = \frac{{\sum }_{{t}_{i} ∈ {D}_{d}} ( {t}_{i} [ Y ] = y )}{{\sum }_{{t}_{i} ∈ D} ( {t}_{i} [ Y ] = y )}$$
where
1(.) is one if tᵢ[Y]=y, and 0 otherwise, and
D_{d}⊆D denotes the subset of cases that fulfill all the attribute constraints specified in driver d, and |D_{d}| is the number of the cases contained in the subset.

3. The method of claim 1, further comprising:
Generating the features X^{D} by enumerating all sequences of directly following activities of a case tᵢ,
associating a value of 1 to tᵢ if the sequence appears at least once in the case tᵢ, and of 0 otherwise,
retaining the features X^{D} having a value tᵢ of 1,
computing a precision value P_{X} and a recall value R_{X} for each retained feature X^{D},
removing features X^{D} whose precision and recall values P_{X}, R_{X} are below predetermined threshold values Θₚ, Θᵣ.

4. The method of claim 1, further comprising:
Generating the features X^{I} by enumerating all sequences of indirectly following activities of a case tᵢ,
associating a value of 1 to tᵢ if the feature's sequence's activities appear in the right order at least once in the case's trace tᵢ and of 0 otherwise,
computing, for each feature X, predefined precision and recall values P_{X}, R_{X},
removing features X^{I} whose precision and recall values P_{X}, R_{X} are below predetermined threshold values Θₚ, Θᵣ.

5. The method claim 1, wherein
in a first step,
generating a number |A| candidate features X^{I} of length i=1, |A| being the number of unique activities A comprised in the log L,
calculating recall value R_{X} of the candidate features X^{I},
retaining only those candidate features X^{I} whose recall value R_{X} is larger than or equal to a predefined recall threshold value Θᵣ, thus obtaining a set of frequent candidates,
performing the iteration step:
incrementing the length i by 1
generating candidate features of length i using the set of frequent candidates resulting from the previously executed step,
calculating the recall value R_{X} of the candidate features X^{I} of length i,
retaining only those candidate features X^{I} whose recall value R_{X} is larger than or equal to the predefined recall threshold value Θᵣ, thus obtaining an updated set of frequent candidates,
repeating the iteration step until there are no more frequent candidates.
calculating the precision value P_{X} for all candidates of the set of candidates, keeping those indirect sequence feature X^{I} whose precision values P_{X} are larger than or equal to a predefined threshold value θₚ, the value θₚ being a natural number θₚ>0.

6. The method of claim 3, wherein
the precision and recall values P_{X}, R_{X} are defined as follows:
$${P}_{X} = \frac{{\sum }_{{t}_{i} ∈ D} ( {t}_{i} [ Y ] = y ) \& {t}_{i} [ X ] = 1}{{\sum }_{{t}_{i} ∈ D} {t}_{i} [ X ] = 1}$$
$${R}_{X} = \frac{{\sum }_{{t}_{i} ∈ D} ( {t}_{i} [ Y ] = y ) \& {t}_{i} [ X ] = 1}{{\sum }_{{t}_{i} ∈ D} ( {t}_{i} [ Y ] = y )}$$

7. A machine-readable non-transitory storage medium comprising instructions which when loaded into a computer system controls the computer system to perform the method of claim 1.

8. A computer program stored on a non-transitory storage medium comprising instructions which, when the program is executed by a computer, cause the computer to perform the method of claim 1.
